(19) United States
(12) Patent Application Publication
(10) Pub. No.: US 2024/0042249 A1
(43) Pub. Date: Feb. 8, 2024

(54) WEARABLE AIR PURIFIER

(71) Applicant: Dyson Technology Limited, Wiltshire (GB)

(72) Inventors: Christopher James HOLLOWAY, Swindon (GB); Matthew Jerome JENNINGS, Cheltenham (GB); Emma Victoria CARSON, Swindon (GB); Stephen Benjamin COURTNEY, Gloucester (GB)

(73) Assignee: Dyson Technology Limited, Wiltshire (GB)

(21) Appl. No.: 18/267,321

(22) PCT Filed: Oct. 7, 2021
(86) PCT No.: PCT/GB2021/052599

§ 371 Date: Jun. 14, 2023

(30) Foreign Application Priority Data
Dec. 17, 2020 (GB) 2020011.9

(51) Int. Cl. A62B 18/00; A62B 23/02

(52) U.S. Cl. CPC A62B 18/006; A62B 23/02; A62B 18/003

(57) ABSTRACT

A wearable air purification system having a wearable support configured to be supported on a user's head. The wearable support is attached to an air delivery mask which delivers a flow of air to an air delivery region. A motor for driving the flow of air to the air delivery region is mounted on the wearable support, or on the air delivery mask, and an air filter for purifying the flow of air is mounted on the wearable support, or on the air delivery mask. Each end of the air delivery mask is moveably connected to the wearable support so that the wearable support is able move with respect to the air delivery mask from a deployed position to a stowed position. The volume envelope of the wearable air purification system is larger in the deployed position than in the stowed position.

### TECHNICAL FIELD

The disclosure is directed to improvements relating to wearable air purification systems or ‘purifiers’.

### BACKGROUND

We are all becoming more aware of air quality issues, particularly in larger urban areas but also more generally when in public areas where space between individuals may be limited, such as on public transport. Air quality issues may embrace various types of airborne pollutants such as potentially toxic gases and pollen, to name a couple of examples.

The wearing of various forms of face mask as a means to provide some level of protection against at least one form of airborne pollutants and toxins has generally become more accepted. However, usually such masks are passive and are configured simply as a single layer or multilayer assembly of material which is secured to the face of a user by an adjustable strap of some sort. Some people prefer to wear more complicated masks and respirators which offer a more comprehensive filtering functionality, but this usually comes at the expensive of comfort and style. They also are a barrier to clear communication.

Various approaches are apparent in the art that are intended to provide a similar or better level of air purification functionality, but which don't require a user to completely obscure their nose and mouth area by a tight-fitting mask. For example, one approach involves a wearable support such as a neckband or headband to which is attached a mask or visor which stretches around in front of the mouth and delivers a jet of filtered air. Such approaches show some promise over conventional fabric masks, but they still tend to obscure the user's facial features significantly. They also tend to be bulky which can sometimes be seen as limiting their practicality as an object for daily wear. The current disclosure is direct to addressing at least some of these challenges.

### SUMMARY OF THE INVENTION

According to a first aspect of the invention, there is provided a wearable air purification system comprising:
a wearable support configured to be supported on a head region of a user, wherein the wearable support comprises first and second ends;
an air delivery mask that includes first and second ends and which is shaped to bound an air delivery region, wherein the air delivery mask is configured to deliver a flow of air to the air delivery region in use;
a motor for driving the flow of air to the air delivery region, wherein the motor is mounted on the wearable support, or on the air delivery mask; and
an air filter for purifying the flow of air, wherein the air filter is mounted on the wearable support, or on the air delivery mask,
wherein the first and second ends of the air delivery mask are moveably connected to the wearable support such that the wearable support can move with respect to the air delivery mask from a deployed position to a stowed position, wherein the volume envelope of the wearable air purification system is larger in the deployed position than in the stowed position.

The wearable air purification system of the present invention is advantageous as it may be more easily stored in a handbag, glove box or carry case for example.

Optionally the air delivery mask is moveably connected to the wearable support by one or more intermediate supports. This has the potential to increase the number of degrees of freedom that the various components of the air purification system have with respect to one another and may make assembly of the device easier.

The first and/or second ends of the air delivery mask may optionally be slidable with respect to the wearable support so that the relative distance between the air delivery mask and the wearable support is variable. This is advantageous for storage and for better fitting of the air purification system to the user.

In one example, the first and/or second ends of the air delivery mask may be pivotable with respect to the wearable support. This allows the angle between the air delivery mask and the wearable support to be adjusted to better fit the end user and allows the wearable support to folded over or under the air delivery mask for storage.

Optionally the wearable support comprises a first side support and a second side support, wherein the first end of the air delivery mask is moveably connected to the first side support, and wherein the second end of the air delivery mask is moveably connected to the second side support. This arrangement provides for an open backed design which may be beneficial for users wishing to drive whilst wearing the mask or who wish to wear a ponytail.

The first side support may optionally be moveably connected to the second side support by an adjustable support band to provide extra support during wear.

In one example, the wearable support may be moveable with respect to the air delivery mask from the deployed position to a stowed position in which the wearable support is substantially received within an area bounded by the air delivery mask, or the air delivery mask is substantially received within an area bounded by the wearable support. This provides an efficient means of packing the wearable support within the air delivery mask, or packing the air delivery mask within the wearable support.

Optionally the wearable support comprises a first surface extending from the first end of the wearable support to the second end of the wearable support, and the air delivery mask comprises a first surface extending from the first end of the air delivery mask to the second end of the air delivery mask, wherein the wearable support is pivotable with respect to the air delivery mask from a stowed position in which the first surface of the wearable support is substantially opposite the first surface of the air delivery mask, to a deployed position in which the first surface of the wearable support and the first surface of the air delivery mask are angularly displaced from one another. In this example, when in the stowed position, the wearable support is located under or over the air delivery mask to provide a compact and robust storage configuration.

The wearable support may optionally be pivotable from a first position in which a portion of the wearable support is located towards the back of the head region of a user in use, to a second position in which said portion of the wearable support is located towards the top of the head region of a user in use. The ability to move the wearable support from the back of the head to the top of the head may be beneficial for users wishing to drive whilst wearing the mask or who wish to wear a ponytail.

In one example, the wearable support comprises a headband. A headband configuration for the wearable support is beneficial as it provides a fit similar to a set of headphones which a user may already be comfortable and familiar with wearing.

Optionally the wearable air purification system may comprise an adjustable support band for facilitating support of the wearable air purification system on the head region of a user, wherein the adjustable support band is moveable with respect to the air delivery mask and/or the wearable support. The use of an adjustable support band provides additional security of fit. This may be of particular benefit to child users.

The adjustable support band may optionally be moveable from a deployed position to a stowed position in which the adjustable support band is substantially received within an area bounded by the air delivery mask or the wearable support; or the air delivery mask or the wearable support is substantially received within an area bounded by the adjustable support band. This provides an efficient means of packing the adjustable within the envelope of the air delivery system.

In one example the wearable support and/or the air delivery mask optionally comprises at least two parts which are moveable with respect to one another such that the size of the wearable support is adjustable to allow the user to select the best fit for them.

Optionally, at least part of the air delivery mask and/or the wearable support are flexible such that the shape of the air delivery mask and/or the wearable support is adjustable in dependence on the size of the air delivery mask and/or the wearable support and/or the size of the adjustable support band. This allows the user to select the best fit for them.

The wearable support may optionally be configured to positively engage with the air delivery mask, and/or the one or more intermediate supports, in the deployed position and/or stowed position so that the wearable support is releasably fixed in position with respect to the air delivery mask when in the deployed and/or stowed position. This is advantageous as it prevents the air purification system from unintentionally changing configuration during use or storage.

In one example the wearable support may optionally be releasably fixable in a plurality of positions with respect to the air delivery mask so that the user may select their preferred configuration.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

The above and other aspects of the invention will now be described, by way of example only, with reference to the accompanying drawings, in which:

FIG. 1a is a schematic side view of a wearable air purification system in a deployed configuration;

FIG. 1b is a schematic side view of the wearable air purification system of FIG. 1a in a stowed configuration;

FIG. 2 is a schematic side view of a user wearing an alternative wearable air purification system in a deployed configuration;

FIG. 3 is a schematic side view of a user wearing an air purification system similar to that of FIG. 2 in a secondary deployed configuration;

FIG. 4 is a schematic perspective view of a further alternative wearable air purification system in a stowed configuration;

FIG. 5 is a schematic side view of a user wearing a wearable air purification system similar to that of FIG. 4 in a deployed configuration;

FIG. 6a is a schematic side view of the wearable air purification system of FIG. 5 in a first optional stowed configuration; and

FIG. 6b is a schematic side view of the wearable air purification system of FIG. 5 in a second optional stowed configuration;

Note that features that are the same or similar in different drawings are denoted by like reference signs.

### SPECIFIC DESCRIPTION

Examples of the invention will now be described in detail in order to provide a thorough understanding of the inventive concept as defined in the claims. However, it will be apparent to the skilled person that the invention may be put into effect without the specific details and that in some instances, well known methods, techniques and structures have not been described in detail in order not to obscure the invention unnecessarily.

In overview, the invention provides a wearable product or item that provides personal air purification in a convenient stylish package. The product, which will now be referred to as an air purifier, is configured to be worn by a user on or around the head so that the user can enjoy a ready source of clean filtered air.

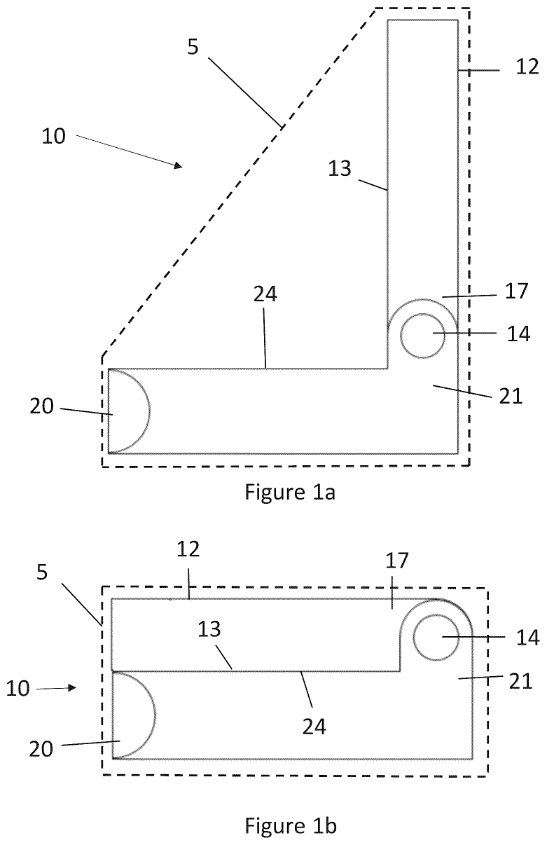

FIG. 1a shows a wearable air purification system, or air purifier, 10 comprising an air delivery mask 20 and a wearable support 12. In this example, the wearable support 12 comprises a headband which, when worn by a user, extends from one side of the user's head to the other.

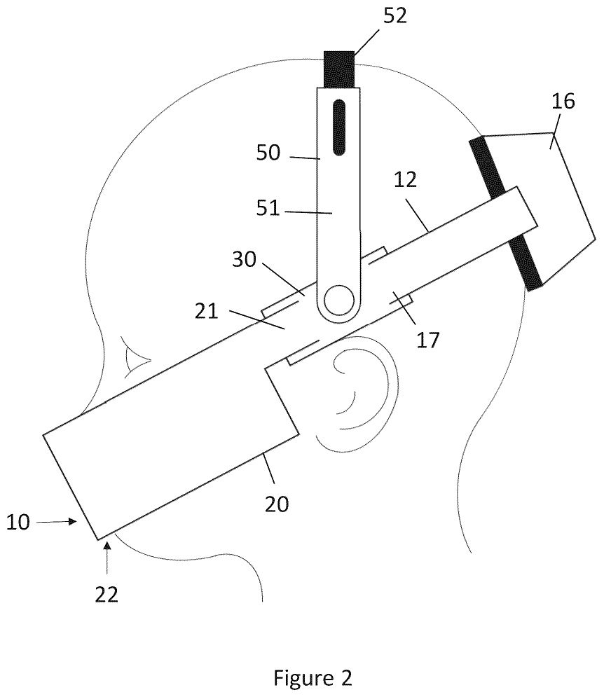

The air delivery mask 20 is configured to extend from one side of a user's face to the other in use so as to bound an air delivery region 22 located substantially in front of a user's mouth and/or nose (see FIG. 2).

A motor and an air mover, for example a fan, (not shown) for driving a flow of air to the air delivery region 22 is mounted on or in the air delivery mask 20 or wearable support 12, and an air filter (not shown) for purifying the flow of air is mounted on or in the air delivery mask 20 or wearable support 12.

A first end 17 of the wearable support 12 is connected to a first end 21 of the air delivery mask 20 by a pivotable connection 14. A similar arrangement exists of the other side (not shown) of the air purifier 10 such that a second end of the wearable support 12 is connected to a second end of the air delivery mask 20 by a pivotable connection 14.

The wearable support 12 comprises a first surface 13 which extends from the first end 17 of the wearable support 12 to the second end (not shown) of the wearable support 12. Similarly, the air delivery mask 20 comprises a first surface 24 extending from the first end 21 of the air delivery mask 20 to the second end (not shown) of the air delivery mask 20. In this example embodiment, when in the deployed position as shown in FIG. 1a, the first surface 13 of the wearable support 12 is angularly displaced form the first surface 24 of the air delivery mask 20 by approximately 90°.

FIG. 1b shows the air delivery mask 10 of FIG. 1a in a stowed configuration in which the first surface 13 of the wearable support 12 is positioned substantially opposite the first surface 24 of the air delivery mask 20. When in the stowed configuration, the air purifier 10 has a smaller volume envelope 5 than when it is in the deployed configuration of FIG. 1a. That is to say, the minimum volume of space required to completely envelope the air purifier 10 is smaller when the wearable support 12 is in the stowed position than when the wearable support 12 in in the deployed position and angularly displaced from the air delivery mask 20. This has the advantage of allowing the air purifier 10 to be stored in a smaller space, such as a handbag or carry case, when not in use.

It will be understood that the angular separation between the first surface 13 of the wearable support 12 and the first surface 24 of the air delivery mask 20 shown in FIG. 1a is an example only and that the angular displacement between the wearable support 12 and the air delivery mask 20 may be selected to be any suitable angle which best suits the end user. In particular, it will be understood that the wearable support 12 may be positioned by the user at a number of different angular positions with respect to the air delivery mask 20 as best suits their needs.

Optionally, the wearable support 12 may be temporarily fixed in position with respect to the air delivery mask 20 in the deployed position and/or the stowed position. This may be achieved by means of a resilient boss located on the wearable support 12 or the air delivery mask 20 which releasably engages with a detent on the other of the wearable support 12 or the air delivery mask 20. Other means of temporarily fixing the position of the wearable support 12 with respect to the air delivery mask 20 are known to persons skilled in the art. Alternatively the pivotable connection 14 may comprise a friction material to provide a degree of frictional hold between the wearable support 12 and the air delivery mask 20.

The wearable support 12 and/or the air delivery mask 20 may be adjustable in length by means of a slidable or concertinaed connection for example.

In an alternative arrangement, the wearable support 12 may pivot towards the air delivery mask 20 such that it is received substantially within an area bounded by the air delivery mask 20. Alternatively, the wearable support 12 may pivot towards the air delivery mask 20 such that the air delivery mask 20 is substantially received within an area bounded by the wearable support 12.

FIG. 2 shows an alternative example of an air purifier 10 in a deployed configuration and worn by a user. The air purifier 10 of this example comprises a wearable support 12 that passes around the back of the head region of the user in use. An air purification device 16 comprising a motor and/or a filter is mounted on by the wearable support 12 and positioned such that, in use, the air purification device is located towards the back of the user's head. An air delivery mask 20 is connected to the wearable support 12 by an intermediate support 30. A corresponding intermediate support is located on the other side of the air purifier 10 (not shown).

A first end 21 of the air delivery mask 20 is slidably connected to the intermediate support 30 and a second end (not shown) of the air delivery mask 20 is slidably connected to the intermediate support on the other side of the air purifier 10. Similarly, A first end 17 of the wearable support 12 is slidably connected to the intermediate support 30 and a second end (not shown) of the wearable support 12 is slidably connected to the intermediate support on the other side of the air purifier 10. The overall length of the air purifier is thereby adjustable by means of sliding the air delivery mask 20 and/or the wearable support 12 with respect to the intermediate supports 30. This allows the air purifier 10 to be configured to suit the dimensions of the user's head.

An optional adjustable support band 50 is pivotally connected to the intermediate supports 30. The adjustable support band 50 comprises two side pieces 51 (only one shown in FIG. 2) and a connecting piece 52 which is slidably attached to one of the side pieces 51 to facilitate adjustment of the length of the support band 50. It will be understood that other mechanisms of length adjustability may be employed in the support band 50 and that the above is an example only. The connecting piece 52 may optionally be slidably attached to both of the side pieces 51 to facilitate adjustment of the length of the support band 50. The wearable support 12 may be configured to fit against and hold the users head to support the air purifier 10 in use. This is particularly beneficial when If no adjustable support band 50 is used.

The example air purifier 10 of FIG. 2 may be placed into a stowed configuration by sliding the air delivery mask 20 and wearable support 12 towards one another to reduce the overall length, and hence the volume envelope 5, of the air purifier 10. If used, the optional adjustable support bad 50 may be rotated towards the air delivery mask 20 or the wearable support 12 so that it is substantially in line with the air delivery mask 20 or the wearable support 12. In this position, the adjustable support bad 50 passes either in front of the air delivery mask 20 or behind the air purification device 16. As for FIGS. 1a and 1b described above, the wearable support 12, the air delivery mask 20, and/or the adjustable support 50, if used, may be temporarily fixed in position with respect to the intermediate supports 30 in the deployed position and/or the stowed position.

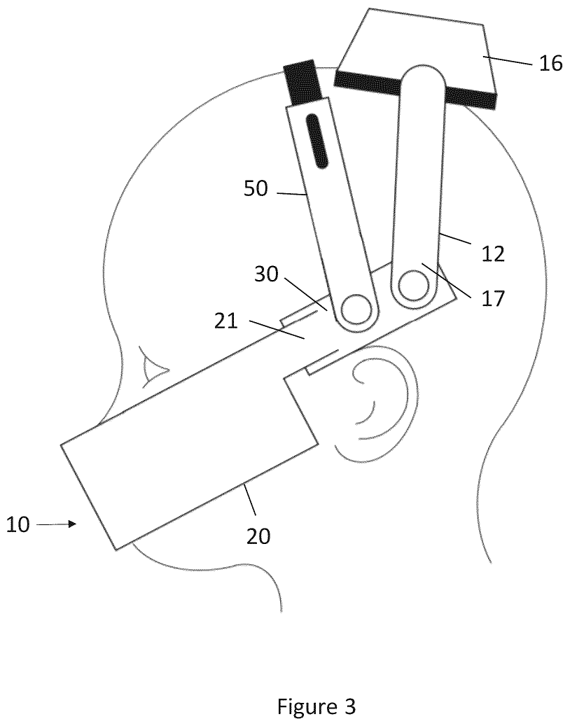

FIG. 3 shows a schematic side view of a further alternative example of an air purifier 10. The air purifier 10 of FIG. 3 is similar in all respects to the air purifier shown in FIG. 2 and described above apart from the fact that the wearable support 12 of the air purifier 10 of FIG. 3 is pivotally connected to the intermediate support 30 it its first 17 and second ends. This pivotable connection allows the air purifier 10 of FIG. 3 to be worn in two deployed configurations; a primary deployed configuration in which the wearable support 12 is positioned substantially as shown in FIG. 2, and a secondary deployed configuration as shown in FIG. 3.

When in the secondary deployed configuration, the wearable support 12 is pivoted upwardly so that it passes over a rearward portion of the user's head in use. The ability to pivot the wearable support 12 from the primary deployed configuration to the secondary deployed configuration is beneficial as it allows the user the option to configure the air purifier 10 in use depending on the particular circumstances. For example the secondary deployed position may be more suitable if the user is driving a car or wearing a ponytail.

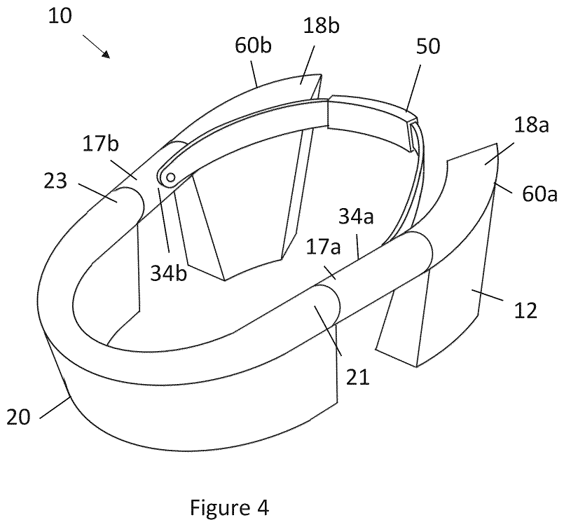

FIG. 4 shows a still further alternative example of an air purifier 10. In this example, the wearable support 12 comprises a first side support 60a which extends from a first end 17a to a second end 18a, and a second side support 60b which extends from a first end 17b to a second end 18b. The first end 17a of the first side support 60a is connected to a first end 21 of the air delivery mask 20, and the first end 17b of the second side support 60b is connected to a second end 23 of the air delivery mask 20.

The air purifier 10 of FIG. 4 comprises an adjustable support band 50 which is pivotally connected to an inner surface 34a, 34b of the first 60a and second 60b side supports respectively. When the air purifier 10 of FIG. 4 is in use in the deployed configuration (not shown), the adjustable support band 50 passes over the user's head from one side of the user's head to the other. When the user wishes to stow the air purifier 10, the volume envelope 5 of the air purifier 10 may be reduced by pivoting the adjustable support 50 rearward towards the second ends 18a, 18b of the side supports 60a, 60b as shown in FIG. 4, or forward towards the air delivery mask 20. Because the adjustable support 50 is pivotally connected to the inner surfaces 34a, 34b of the side supports 60a, 60b, when in the stowed position, the adjustable support 50 resides within the volume envelope 5 of the air purifier 10 as defined by the air delivery mask 20 and the wearable support 12 consisting of side supports 60a, 60b.

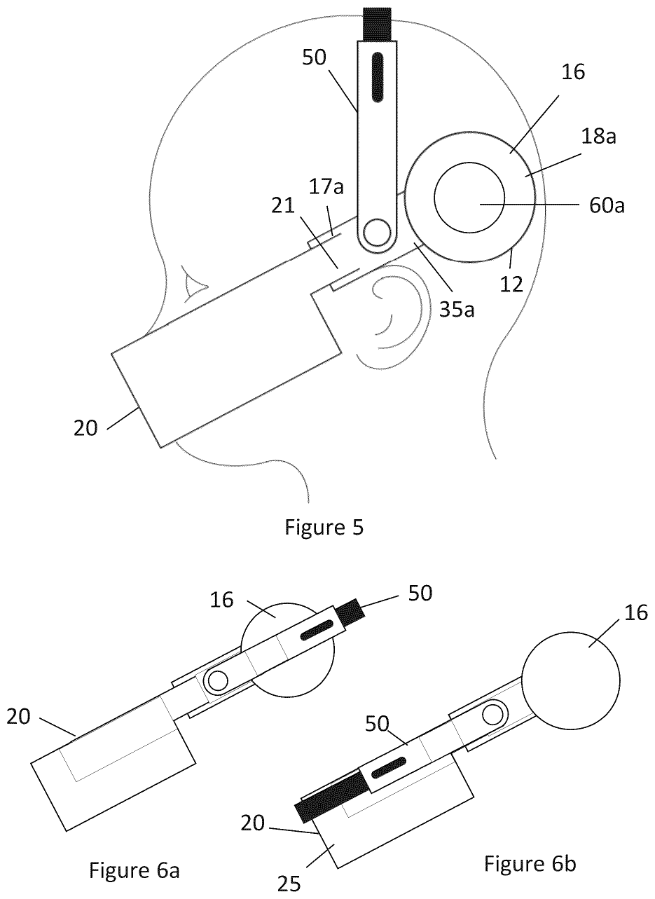

If desired, one or both of the first 60a or second 60b side supports may be connected to the respective first 21 and second 23 ends of the air delivery mask 20 by a slidable and or pivotable connection. The connection between the first 60a and second 60b side supports and the air delivery mask 20 may comprises an intermediate support such as that described above in relation to FIGS. 2 and 3, or below in relation to FIGS. 5 and 6. In an alternative example, the side supports 60a, 60b may be integral with the air delivery mask 20. It will be understood that the two-piece wearable support 12 of FIG. 4 could be substituted for a one-piece wearable support such as that shown in FIGS. 2 and 3 and described above.

FIG. 5 show a further alternative example of an air purifier 10 comprising a two-part wearable support 12 and an air delivery mask 20. In this example the first end 21 of the air delivery mask 20 is slidably connected to the first end 17a of the first side support 60a.

An equivalent arrangement exists on the other side of the air purifier 10 (not shown) where the second end of the air delivery mask 20 is slidably connected to the first end of the second side support. An air purification device 16 is mounted at the second end 18a of the first side support 60a and the second end of the second side support (not shown) respectively.

The air purifier 10 of FIG. 5 comprises an adjustable support band 50 which is pivotally connected to an outer surface 35a of the first side support 60a and an outer surface of the second side support (not shown). When the air purifier 10 of FIG. 5 is in used in the deployed configuration as shown, the adjustable support band 50 passes over the user's head from one side of the user's head to the other. When the user wishes to stow the air purifier 10, the volume envelope of the air purifier 10 may be reduced by pivoting the adjustable support 50 rearward towards the second ends of the side supports as shown in FIG. 6a, or forward towards the air delivery mask 20 as shown in FIG. 6b. Because the adjustable support 50 is pivotally connected to the outer surfaces of the side supports, when in the stowed position, the adjustable support 50 is located adjacent to an outer surface 25 of the air delivery mask 20 or adjacent to the outer surfaces 35a of the side supports.

In any of the examples discussed above, the air delivery mask 20 and/or the wearable support 12 may be flexible such that the width of the air delivery mask 20 and/or the wearable support 12 can change in dependence upon the set-up of another component. For example, the width of the air delivery mask 20 and/or the wearable support 12 may be dependent on the size to which an attached adjustable support band 50 is set. Alternatively, the width of the air delivery mask 20 may be dependent upon the size to which a wearable support 12 is set, or vice versa.

It will be apparent to the skilled person that there are many possible layouts and arrangements for an air purifier 10 and that the above described embodiments are given as examples only and are not to be considered as limiting. In particular, it will be clear that the air delivery mask 20, the wearable support 12, and optional adjustable support band 50 may be integral with one another or connected together directly or indirectly in a fixed or moveable connection.

1: A wearable air purification system comprising:
a wearable support configured to be supported on a head region of a user, wherein the wearable support comprises first and second ends;
an air delivery mask that includes first and second ends and which is shaped to bound an air delivery region, wherein the air delivery mask is configured to deliver a flow of air to the air delivery region in use;
a motor for driving the flow of air to the air delivery region, wherein the motor is mounted on the wearable support, or on the air delivery mask; and
an air filter for purifying the flow of air, wherein the air filter is mounted on the wearable support, or on the air delivery mask,
wherein the first and second ends of the air delivery mask are moveably connected to the wearable support such that the wearable support can move with respect to the air delivery mask from a deployed position to a stowed position, wherein the volume envelope of the wearable air purification system is larger in the deployed position than in the stowed position.

2: The wearable air purification system as claimed in claim 1, wherein the air delivery mask is moveably connected to the wearable support by one or more intermediate supports.

3: The wearable air purification system as claimed in claim 1, wherein the first and/or second ends of the air delivery mask are slidable with respect to the wearable support.

4: The wearable air purification system as claimed in claim 1, wherein the first and/or second ends of the air delivery mask are pivotable with respect to the wearable support.

5: The wearable air purification system as claimed in claim 1, wherein the wearable support comprises a first side support and a second side support, wherein the first end of the air delivery mask is moveably connected to the first side support, and wherein the second end of the air delivery mask is moveably connected to the second side support.

6: The wearable air purification system as claimed in claim 5, wherein the first side support is moveably connected to the second side support by an adjustable support band.

7: The wearable air purification system as claimed in claim 1, wherein the wearable support is moveable with respect to the air delivery mask from the deployed position to a stowed position in which:
the wearable support is substantially received within an area bounded by the air delivery mask; or
the air delivery mask is substantially received within an area bounded by the wearable support.

8: The wearable air purification system as claimed in claim 4, wherein the wearable support comprises a first surface extending from the first end of the wearable support to the second end of the wearable support, and wherein the air delivery mask comprises a first surface extending from the first end of the air delivery mask to the second end of the air delivery mask, wherein the wearable support is pivotable with respect to the air delivery mask from a stowed position in which the first surface of the wearable support is substantially opposite the first surface of the air delivery mask, to a deployed position in which the first surface of the wearable support and the first surface of the air delivery mask are angularly displaced from one another.

9: The wearable air purification system as claimed in claim 1, wherein the wearable support is pivotable from a first position in which a portion of the wearable support is located towards the back of the head region of a user in use, to a second position in which said portion of the wearable support is located towards the top of the head region of a user in use.

10: The wearable air purification system as claimed in claim 1, wherein the wearable support comprises a headband.

11: The wearable air purification system as claimed in claim 1, comprising an adjustable support band for facilitating support of the wearable air purification system on the head region of a user, wherein the adjustable support band is moveable with respect to the air delivery mask and/or the wearable support.

12: The wearable air purification system as claimed in claim 11, wherein the adjustable support band is moveable from a deployed position to a stowed position in which:
the adjustable support band is substantially received within an area bounded by the air delivery mask or the wearable support; or
the air delivery mask or the wearable support is substantially received within an area bounded by the adjustable support band.

13: The wearable air purification system as claimed in claim 1, wherein the wearable support comprises at least two parts which are moveable with respect to one another such that the size of the wearable support is adjustable.

14: The wearable air purification system as claimed in claim 1, wherein the air delivery mask comprises at least two parts which are moveable with respect to one another such that the size of the air delivery mask is adjustable.

15: The wearable air purification system as claimed in claim 13, wherein at least part of the air delivery mask and/or the wearable support are flexible such that the shape of the air delivery mask and/or the wearable support is adjustable in dependence on the size of the air delivery mask and/or the wearable support and/or the size of the adjustable support band if present.

16: The wearable air purification system as claimed in claim 1, wherein the wearable support is configured to positively engage with the air delivery mask, and/or the one or more intermediate supports if present, in the deployed position and/or stowed position so that the wearable support is releasably fixed in position with respect to the air delivery mask when in the deployed and/or stowed position.

17: The wearable air purification system as claimed in claim 16, wherein the wearable support is releasably fixable in a plurality of positions with respect to the air delivery mask.
